(19) United States
(12) Patent Application Publication
(10) Pub. No.: US 2024/0004467 A1
(43) Pub. Date: Jan. 4, 2024

(54) MAN/MACHINE INTERFACE COMPRISING A GLOVE

(71) Applicant: COMMISSARIAT A L'ENERGIE ATOMIQUE ET AUX ENERGIES ALTERNATIVES, Paris (FR)

(72) Inventors: Bryden DEBOON, Gif-Sur-Yvette (FR); Moustapha HAFEZ, Gif-Sur-Yvette (FR); Christine MEGARD, Gif-Sur-Yvette (FR); Florent SOUVESTRE, Gif-Sur-Yvette (FR)

(73) Assignee: COMMISSARIAT A L'ENERGIE ATOMIQUE ET AUX ENERGIES ALTERNATIVES, Paris (FR)

(21) Appl. No.: 18/253,326

(22) PCT Filed: Nov. 21, 2021
(86) PCT No.: PCT/EP2021/081470

§ 371 Date: May 17, 2023

(30) Foreign Application Priority Data
Nov. 17, 2020 (FR) FR2011798

(51) Int. Cl. G06F 3/01; G06F 3/0346; G06F 3/038

(52) U.S. Cl. CPC G06F 3/014; G06F 3/0346; G06F 3/0383; G06F 3/017; G06F 2203/0384

(57) ABSTRACT

Man/machine interface comprising—a glove which comprises o at least one transmitter which is integrated into the glove and which comprises at least one coil for emitting a magnetic field, which coil is arranged on a finger of the glove so that the orientation of the emitted field relative to a reference direction in a reference system connected with the glove changes with that of the finger, o at least one processing circuit which is integrated into the glove and which comprises at least one receiver for receiving the signal emitted by the transmitter, which receiver is configured to process the signal received in order to determine at least the orientation of the coil of the transmitter in the reference system.

### TECHNICAL FIELD

The present invention relates to human-machine interfaces, and more particularly those that recognize at least certain movements of the fingers.

### PRIOR ART

It is known to detect the gestures of the hands using human-machine interfaces comprising an external visual evaluation system, such as a camera for example, coupled with an image-processing algorithm. However, these interfaces are not entirely suitable for mobile applications.

Moreover, wearable electronic devices that detect the movement of the hands generally comprise sensors, attached to the hand or placed in proximity thereto, these having the drawback of sometimes being invasive for the user. In addition, these sensors may be connected by wired connections to a processing circuit, this running the risk of faster degradation of the device.

Patent applications US 2017/090568 and US 2016/246270 disclose a glove comprising emitters and one or more receivers allowing the position and orientation of the fingers of the hand to be determined, and certain gestures to be deduced therefrom. Such devices may be subject to gesture-detection errors in situations where the electromagnetic environment interferes with the signals from the emitters.

The article “Auraring: Precise electromagnetic finger tracking” describes a wearable device for detecting the movements of a finger. This device comprises a ring with an integrated coil emitting an electromagnetic field, and a receiver bracelet equipped with a number of sensors that determine the position and orientation of the ring. The ring is entirely independent of the rest of the device, with the drawback that it must be self-powered by a battery that may hinder the freedom of movement of the finger, its autonomy further being restricted by size constraints thereof. Moreover, this one-ring system allows only movements of a single finger of the hand to be detected, substantially limiting the field of application of the technology.

### DISCLOSURE OF THE INVENTION

There is therefore a need to further improve human-machine interfaces as regards recognition of hand movements, especially in order to obtain a device capable of evaluating at least the orientation, and better still also the position, of at least one finger of the hand autonomously. It would also be advantageous to obtain a relatively robust and wearable device, allowing the user to perform many tasks while remaining mobile and keeping his or her hands free.

### SUMMARY OF THE INVENTION

The invention aims to meet this need, and it does so, according to a first of its aspects, by virtue of a human-machine interface (HMI), comprising
a glove comprising
   at least one emitter integrated into the glove, comprising at least one coil for emitting a magnetic field, said coil being placed on a finger of the glove such that the orientation of the emitted field relative to a reference direction in a reference frame tied to the glove varies with the orientation of the finger,
   at least one processing circuit integrated into the glove, comprising at least one receiver of the signal emitted by the emitter, said circuit being configured to process the received signal in order to determine at least the orientation of the coil of the emitter in said reference frame.

By virtue of the invention, a robust and reliable interface that is relatively comfortable for the user to wear, and that meets the constraints of mobility, is obtained.

Integration of the coil of the emitter into a finger of the glove is relatively simple to achieve because the coil may be of small size, and the wires to be integrated into the glove to power it or power the emitter may be of small cross-sectional area and relatively few in number.

In examples of implementation of the invention, only the coil is integrated into the finger of the glove and said coil is connected to a remote oscillator, for example forming part of the processing circuit. This allows the space occupied on the fingers to be minimized. As a variant, the entire emitter, i.e. the oscillator and the coil, is integrated into the finger of the glove. This may allow the emission of parasitic signals to be decreased, and processing of the received signal to be facilitated.

Preferably, the glove comprises at least one electrical source common to the emitter and to the processing circuit, for supplying electricity to them, preferably an electrical source placed on the top of the hand or in the wrist region.

The presence of the one or more emitters is useful in that it allows particular gestures to be detected. The interface advantageously comprises a system allowing detection of one or more presses in one or more predefined regions of the glove. The processing circuit may thus advantageously be arranged to detect a press on at least one predefined contact point of the glove by one of the fingers of the user wearing this glove.

In particular, the processing circuit may be arranged to detect a mutual press between two predefined contact points of the glove, these contact points being placed on the glove so as to allow the user to selectively bring these points into contact or not, by moving at least one finger of the hand. Preferably, at least one contact point is located on the thumb and at least one other is located on the index and/or middle finger.

The contact points may be defined by various detecting means and may each comprise for example an electrode connected by a wired connection to the processing circuit.

Generally, the processing circuit may be arranged to detect a press on a contact point via resistive, capacitive, optical, inductive, electromechanical, thermal, piezo-resistive or piezoelectric detection.

In examples of embodiment, the glove comprises at least two contact points placed so as to allow the user to selectively bring them into contact, each of these contact points comprising an electrode connected by a wired connection to the processing circuit, the latter being arranged to detect, via resistive or capacitive detection, a mutual press between these contact points.

Preferably, the interface comprises at least a first module able to communicate via a wireless link, and preferably via two-way radio-telemetry, with at least a second module external to the glove in order to determine the position of the glove relative to the reference frame of the external module. The first module is preferably located in the wrist region, and the one or more external modules may be worn by the user, for example on a belt, in a pocket or on a headset. Each module may comprise a receiver/emitter.

In another example of embodiment, the external module is fixed in the external environment, and for example not worn by the user wearing the glove.

The first module and the one or more external modules may communicate via a two-way wireless link, preferably of the radio-frequency type, for example using ultra wideband (UWB) modulation technology. By virtue of the communication with the one or more external modules, the position of the glove with respect to the reference frame of the one or more external modules may be determined, and also, if useful, the position of the one or more coils worn on the fingers relative to this or these external reference frames may be determined. Thus, new gestures involving a movement of the hand or of the arms may advantageously be detected. This further allows finger gestures that are identical but performed at distinct spatial positions to be discriminated between, or allows more complex sequences of finger and hand or arm movements to be detected. Thus, the interface may be arranged to transmit information by decoding not only the movement of the fingers in the reference frame of the glove but also of the glove in an external reference frame, which may optionally be tied to the user. This external reference frame is for example fixed relative to a belt or a headset, or any other part of the user, as mentioned above.

Preferably, the interface comprises at least two emitters or emitter coils placed on two different fingers or on two different phalanges of the same finger, and better still at least three different emitters or emitter coils placed on three different fingers. The interface may thus comprise at least one emitter or emitter coil on each of the thumb, index finger and/or middle finger.

Preferably, the emitters emit at different frequencies, the processing circuit being arranged to discriminate between the signals of each emitter.

Preferably, the processing circuit is arranged to determine the amplitude and phase of the signal received by the receiver and originating from the emitter.

The or each emitter is preferably powered electrically via a wired connection, when it is not placed within the processing circuit. As a variant, i.e. for example when the entirety of an emitter is located on a finger and it is not powered via a wired connection, power may be supplied to the emitter wirelessly, by induction.

The processing circuit is preferably located in the wrist region, this minimizing the discomfort caused when wearing the glove, and making it possible to minimize the presence of electrical components on the fingers.

Preferably, the processing circuit comprises a transmitter for transmitting data to third-party equipment via a wireless link, these data resulting from the detected orientation and/or gesture. This wireless link may be of any type, for example a radio-frequency or optical link. Where appropriate, the aforementioned first module is used to transmit these data, and the aforementioned second module may serve as a relay for transmission to the third-party equipment.

The processing circuit is preferably configurable so as to allow a user to define a command to be generated as output depending on at least one detected orientation and/or gesture. For example, the processing circuit emulates the data transmitted via Bluetooth by a wireless mouse in response to certain detected gestures, this allowing the interface to easily be used to control equipment such as a computer.

The processing circuit may comprise at least one neural network trained beforehand to recognize a predefined gesture made by the user with his or her hand, or even his or her hand and his or her arm, this potentially facilitating recognition of various gestures, and especially a gesture with the fingers or hand made at a predefined height relative to the body.

Another subject of the invention is an assembly comprising:
an interface according to the invention, such as defined above,
an item of equipment able to be connected to the interface so as to receive therefrom data generated as output depending on at least one detected orientation and/or gesture.

The item of equipment may comprise at least one display device, and the output data may control a pointer and/or a selection tool in an image, a menu for example, displayed by the display device.

The item of equipment for example comprises a transceiver and the output data control a state of transmission or of the receiver listening. As a variant, the item of equipment is a land vehicle, ship or aircraft, or forms part of such a vehicle, ship or aircraft, and the output data contribute to guiding said vehicle, ship or aircraft.

This assembly may comprise the first and second module(s) defined above, allowing movements of the arm relative to an external reference frame that is optionally tied to the user to be determined, and for example allowing the height at which a movement of the fingers is made with respect to a reference frame tied to the user to be determined.

Another subject of the invention, according to another of its aspects, is a method for generating at least one item of information for delivery to an item of equipment, using an interface according to the invention, comprising the steps of:
detection of the orientation of at least the finger equipped with the emitter or with the coil of the emitter, and especially a predefined gesture of the hand,
based on this detection, generating a predefined item of information for delivery to the item of equipment.

The predefined gesture for example consists in joining the index and middle fingers along their length, the invention not however being limited to this single gesture. The predefined gesture may comprise a combined finger and arm gesture. It is thus possible to detect the position of the hand relative to a reference frame external to the glove, especially a reference frame tied to the user, and to use knowledge of the orientation and/or position of the fingers in the reference frame tied to the glove and of the glove in the reference frame tied to the user to discriminate between gestures involving a movement of the fingers and of the hand.

The predefined gesture is advantageously identified using a pre-trained neural network.

Recognition of the gesture may involve, where appropriate, detection of presses between the fingers on predefined contact points.

It is also possible to subordinate validation of a press detected between two predefined contact points to recognition of a particular gesture prior to detection of the contact; this may make it possible to improve the detection reliability.

### BRIEF DESCRIPTION OF THE DRAWINGS

The invention may be better understood on reading the following detailed description of non-limiting examples of implementation thereof, and on examining the appended drawings, in which:

FIG. 1 schematically and partially represents one example of a human-machine interface according to the invention,

FIG. 2 partially and schematically shows certain details of embodiment of the glove,

FIG. 3 shows in perspective, partially and schematically, a finger of the glove integrating an emitter or an emitter coil,

FIG. 4A illustrates in schematic and partial cross section along line IV in FIG. 3 one example of integration of the emitter or coil against the glove,

FIG. 4B illustrates in schematic and partial cross section along line IV in FIG. 3 one example of integration of the emitter or coil into the wall of the glove,

FIG. 4C illustrates in schematic and partial cross section along line IV in FIG. 3 one example of integration of the emitter or coil that has the latter opening onto the exterior of the glove,

FIG. 5 schematically illustrates the possibility of providing the glove with means for detecting contact between predefined contact points,

FIG. 6A shows an electrode-based variant of embodiment of the detecting means,

FIG. 6B shows a micro-switch-based variant of embodiment of the detecting means,

FIG. 7 partially and schematically shows certain details of embodiment of one example of an interface,

FIG. 8 is a block diagram showing certain details of embodiment of an emitter and of the processing circuit,

FIG. 9 illustrates determination of the position and orientation of the coil of an emitter relative to an associated receiver,

FIG. 10 illustrates the transformations leading to determination of the position and orientation of the hand,

FIG. 11 is a block diagram illustrating steps of one example of a method for determining the gestures of the hand equipped with the glove of the interface,

FIG. 12 partially and schematically illustrates the possibility of the glove communicating via a wireless link with an external module, for example one worn by the user on his or her belt,

FIG. 13 is a block diagram showing certain details of embodiment of the example of FIG. 12,

FIG. 14 illustrates one example of application of the interface, and

FIG. 15 gives another example of use of the interface.

### DETAILED DESCRIPTION

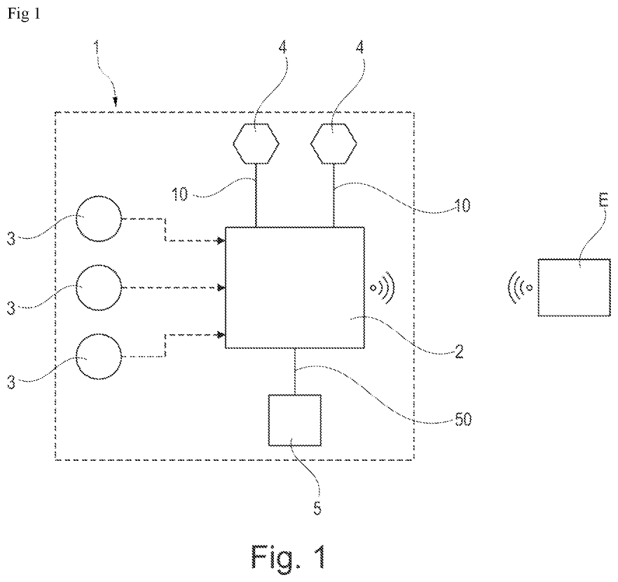

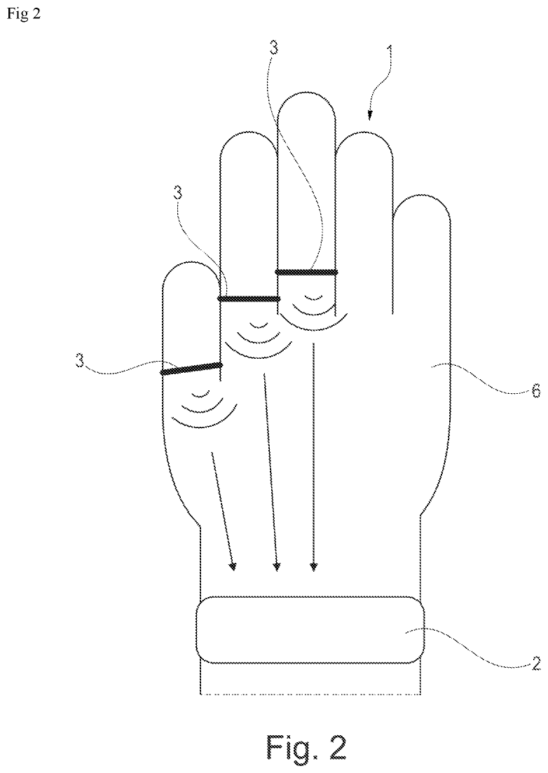

FIGS. 1 and 2 show one example of a human-machine interface 1 according to the invention, comprising a glove 6. This interface 1 comprises N emitters 3, three in number in the example in question. Each emitter 3 is arranged to emit a magnetic signal and comprises a coil integrated into a finger of the glove 6, the emitters preferably emitting at different respective frequencies.

In the example in question, the part of each emitter 3 that is integrated into a finger of the glove 6 has a generally annular shape and extends around the corresponding finger.

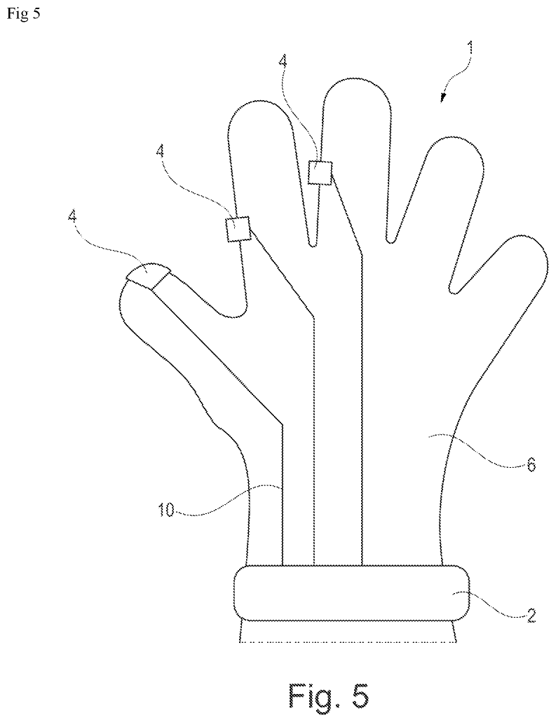

The interface 1 moreover comprises, in the example in question, a plurality of detectors associated with contact points 4, which are connected by wired connections 10 to a processing circuit 2. These contact points 4 are for example positioned on various fingers of the glove 6, as illustrated in FIG. 5.

The processing circuit 2 is advantageously arranged to transmit, to external equipment E, data dependent on the movement made by the hand, this transmission preferably taking place via a wireless link.

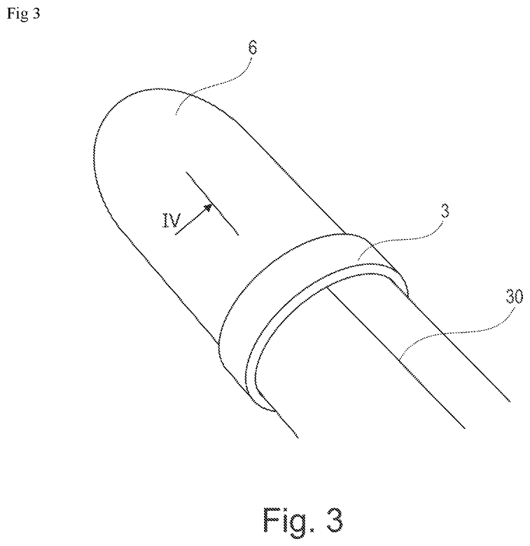

The interface 1 comprises an electrical source 5, a rechargeable battery for example, that is common to the emitters 3 and to the processing circuit 2, for supplying electricity to them, said source for example being connected to the processing circuit 2 by a wired connection 50 and to each of the parts of the emitters 3 extending around the fingers by a respective wired connection 30, as shown in FIG. 3.

The processing circuit 2 is preferably located in the wrist region and the wired connections 50 and 30 are integrated into the wall of the glove 6 so as to be protected from external stresses and direct contact with the user's hand. Depending on the user, the glove 6 may be of a number of sizes and for example comprises a plurality of layers of a resistant textile that are sewn or otherwise assembled together. The electrical source 5 may be placed on top of the glove 6 or in the wrist region so as not to adversely affect the comfort and freedom of movement of the user. The processing circuit 2 may be housed in a casing extending for example all the way around the wrist or over only part thereof. The source 5 may be arranged to be recharged by induction, or using a specific connector.

The orientation of the field emitted by the coil of each emitter 3, relative to a reference direction in a reference frame tied to the glove 6, varies with the orientation of the finger bearing this coil. The processing circuit 2 processes the signal received from each emitter 3 in order to determine the position and orientation of the coil in this reference frame.

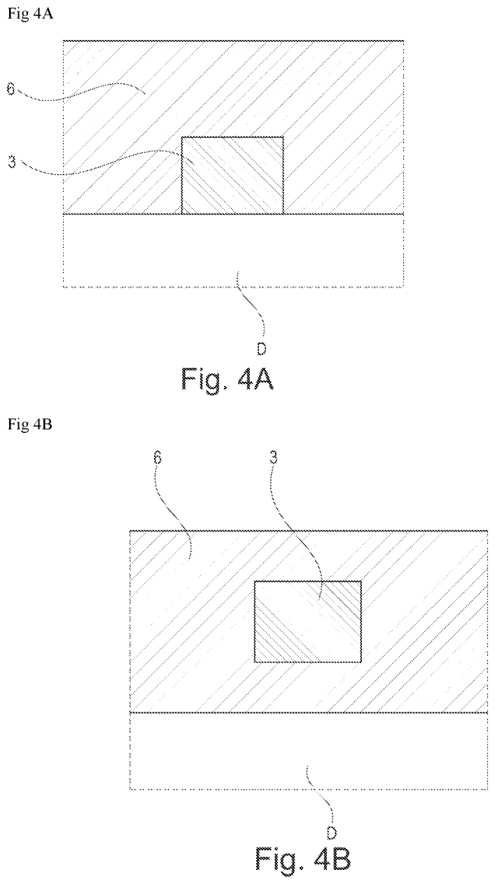

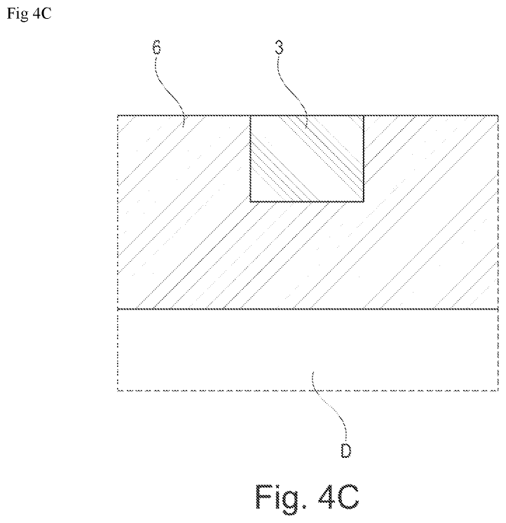

The emitter 3, or the coil thereof, may be integrated into the glove 6 in various ways. In the example of FIG. 4A, the emitter 3 (or its coil) makes contact with the finger D inserted into the glove, this best protecting it from external mechanical stresses.

In the variant of FIG. 4B, the emitter 3 (or its coil) is located within the wall of the glove 6, for example substantially at mid-thickness as illustrated, and thus does not make contact with the finger, this potentially improving the comfort of the wearer of the glove, while nonetheless providing a certain amount of protection from the exterior.

In the variant of FIG. 4C, the emitter 3 (or its coil) is flush with the exterior surface of the glove. Of course, the invention is not limited to one particular way of integrating the emitter 3 into the glove.

The contact points 4 are for example respectively placed on the middle finger and on the index finger, on the side thereof facing the thumb, and the latter may also define a contact point 4 provided with detecting means, so as to be able to detect contact of the contact point present on the thumb with one of those present on the index or middle finger.

The detecting means associated with the contact points 4 may be produced in multiple ways.

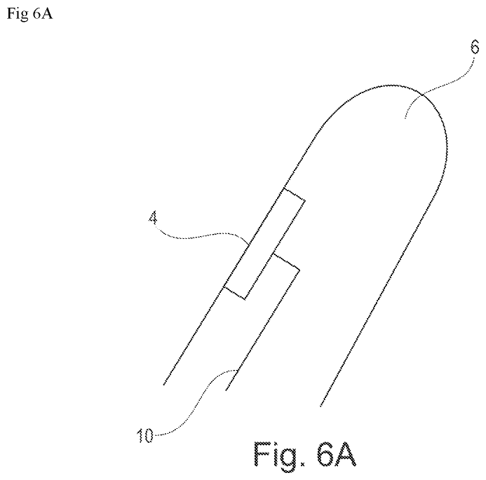

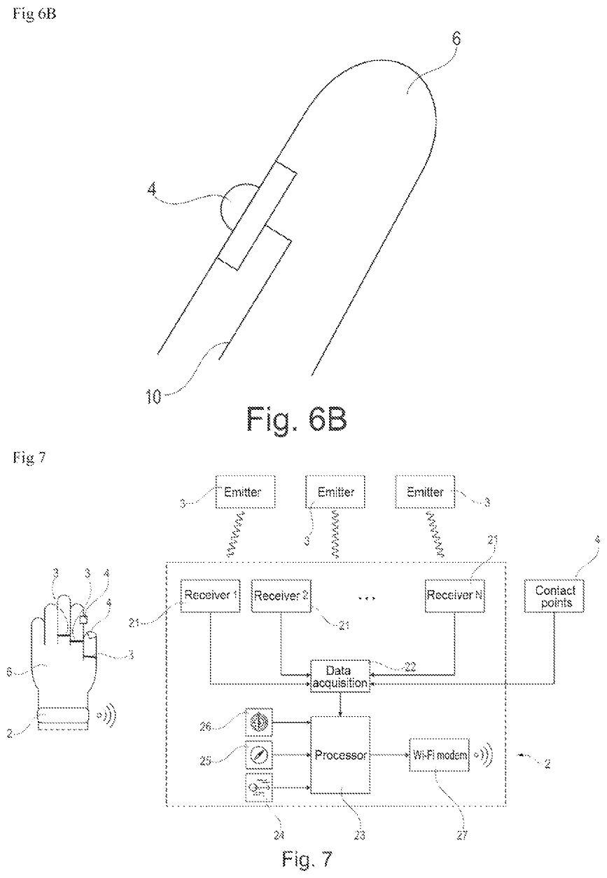

For example, each contact point 4 is defined by an electrode connected by a wired connection 10 to the processing circuit 2. This electrode may be a conductive area present on the exterior surface of the glove, as illustrated in FIG. 6A. In one variant, as illustrated in FIG. 6B, each contact point 4 is associated with a micro-switch.

The invention is not limited to particular means for detecting a mutual press of two fingers against each other at predefined contact points 4, and the detecting means are for example arranged to detect a contact via resistive, capacitive, optical, inductive, electromechanical, thermal or piezoelectric detection, among other possibilities.

FIG. 7 illustrates certain possibilities of embodiment of the interface 1.

The processing circuit 2 comprises, in the example of this figure, N reception channels embodied by as many receivers 21, the receiver of each channel being tuned to the emission frequency of the corresponding emitter 3.

Block 22 illustrates the acquisition of data originating from the receivers 21 and detecting means associated with the contact points 4, these data being processed by a processor 23 of the processing circuit 2. By “processor”, what must be understood is any processing means allowing the data to be processed in order to deliver the sought information, the processor potentially comprising one or more circuits, such as microcontrollers, FPGAs, microprocessors, etc., and the conventionally associated components (memories, converters, clocks, I/O circuits, communication interfaces, etc.).

The processing circuit 2 may further comprise one or more additional sensors, for example as illustrated an accelerometer 24, a magnetic sensor 25 and a gyroscope 26, allowing the acceleration and orientation of the processing circuit 2 (and therefore of the wearer's hand) to be determined in a reference frame outside the glove 6.

In variants, the interface comprises one or more sensors of the physiological state of the wearer, for example of his or her ECG, oxygen level or temperature, of the external environment, for example of the external temperature, of the presence of particular gaseous compounds (for example CO, etc.), of vibrations, of sounds (especially a microphone), of radiation, etc.

The interface 1 may further comprise an antenna for receiving satellite geo-positioning data (for example GPS data) and/or an antenna for communicating with a telecommunications network.

Where appropriate, the interface 1 comprises at least one tactile actuator, a vibrator for example, allowing information to be transmitted to the wearer.

The processing circuit 2 may comprise a modem 27, for example a Wi-Fi or Bluetooth radio-frequency modem, allowing the interface 1 to communicate with third-party equipment via a wireless link.

In one variant, the processing circuit 2 comprises only a single receiver 21, which is used in conjunction with a single emitter at a time, the emitters then being powered sequentially.

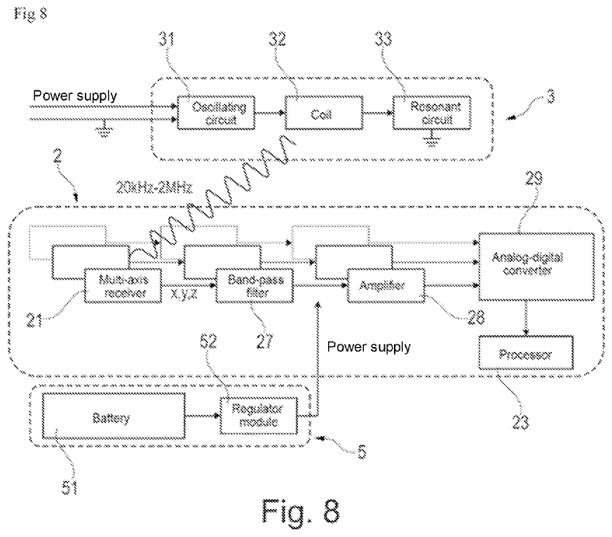

As illustrated in FIG. 8, each emitter 3 may comprise an oscillating circuit 31 exciting a coil 32 forming part of a resonant circuit 33. As mentioned above, all the components of the emitter 3 may be present on the finger, being for example embedded with the coil in an annulus made of a synthetic material, a resin for example. The coil 32 preferably comprises a plurality of turns encapsulated in the annulus of the emitter 3 extending around the finger, and coaxial with the latter.

In one variant, only the coil 32 is integrated into the finger of the glove and said coil is connected to a remote oscillator, for example forming part of the processing circuit 2. In this case, the coil is preferably stiffened by being encapsulated in a resin, so as to allow it to retain its initial shape despite the mechanical stresses applied to the glove 6.

The resonant frequency of resonant circuit 33 is preferably between 20 kHz and 2 MHz. The resonant circuit 33 and the processing circuit 2 are powered by the electrical source 5, which for example comprises, as illustrated, a regulator module 52 supplying a battery 51.

The signal emitted by the coil of each emitter 3 is received by at least one multi-axis receiver 21 present on the wrist, said signal being filtered by a band-pass filter 27 before being amplified by an amplifier 28 with a view to being processed by the processor 23, the data for example being transmitted to the latter by an analog-digital converter 29. As indicated above, the processing circuit may comprise only a single receiver, or as a variant a plurality of receivers.

When the user makes a hand movement, the position and orientation of the magnetic field emitted by the coil of each emitter 3 (located on a finger) varies relative to each multi-axis receiver 21 (located in the wrist region).

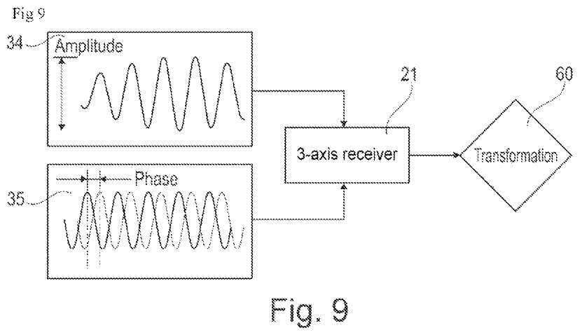

As shown in FIG. 9, the signal received by each multi-axis receiver 21 makes it possible to evaluate, via measurement of the amplitude 34 and phase 35 of the signal in three orthogonal directions, the position and orientation of this coil.

Preferably, the emitters 3 successively emit at different frequencies, each receiver 21 being arranged to discriminate between the signals of the various emitters 3.

Preferably, the interface is calibrated beforehand so as to be able to more easily detect the orientation and position of each emitter coil. This calibration may involve performing a predefined sequence of movements with the hand, for example bringing the hand flat and then moving the fingers in a predefined way.

Preferably, the processing circuit 2 comprises a plurality of receivers 21 integrated into the glove 6, for example three receivers, in the wrist region, the receivers being widely spaced around the wrist so that the measurements carried out by the receivers 21 are different enough for the position and orientation of the coil of each emitter 3 to be determined relatively accurately. In this case, the three receivers 21, each of which is multi-axis, are used simultaneously to detect the signals generated by a given emitter coil. It is thus possible to sequentially analyze the orientations and positions of the coils of the various emitters 3. The emitters 3 may simultaneously emit at different frequencies, or as a variant emit sequentially at different frequencies, or as a further variant emit sequentially at the same frequency.

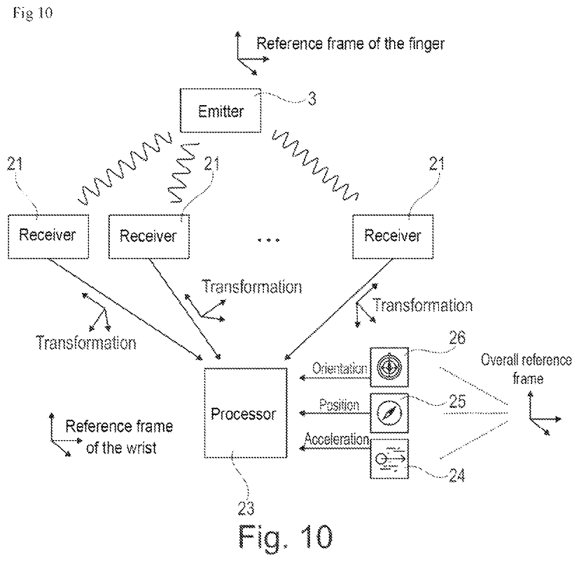

The measurements made by each of the receivers 21 along three orthogonal reception axes (for example using detection coils of orthogonal axes) are grouped together, as illustrated in FIG. 9, in order to determine the position and orientation of the coil of each emitter in the reference frame of the glove, by virtue of a transformation 60 which includes a change of reference frame. These digital data are processed by the processor 23, preferably in combination with glove acceleration, position and orientation data, which are generated by the aforementioned sensors 24 to 26, in order to determine the position and attitude of the hand absolutely, i.e. with respect to a reference frame external to the glove, as illustrated in FIG. 10. Preferably, as detailed below, communication modules may be used to determine the position of the glove in an external reference frame, which reference frame may or may not be tied to the user.

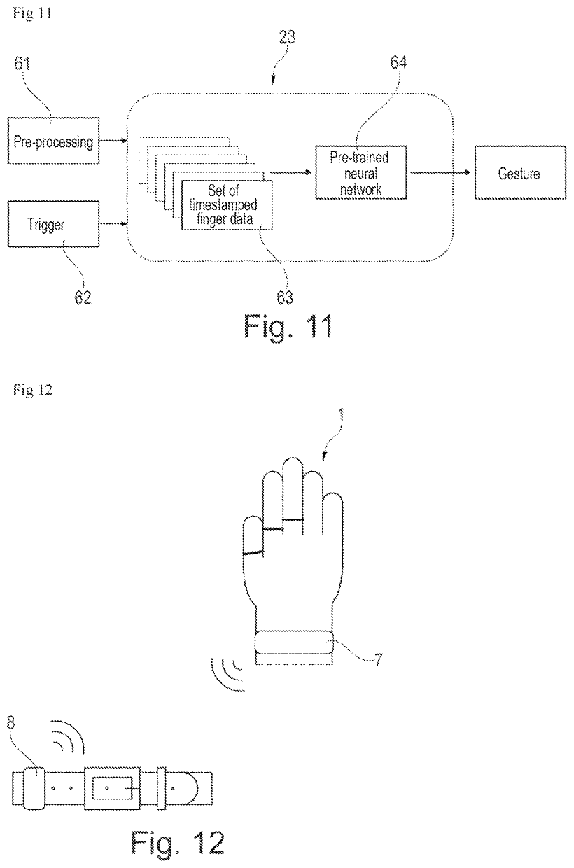

To recognize for example a gesture of the fingers of the hand based on the orientation and position values measured for each emitter 3, it is possible to implement an algorithm such as illustrated in FIG. 11, employing a pre-trained neural network 64.

The neural network 64 is for example arranged to recognize a predefined gesture made by the user with his or her fingers relative to his or her wrist, based on a time-domain sequence of data sets 63 comprising information on the orientation and position of the coils of the emitters 3 placed on the fingers.

The neural network 64 is trained beforehand during a calibrating phase.

The time-domain sequence 63 is obtained following a phase 61 of pre-processing the measurements taken. The process of defining the gesture is for example activated by a triggering event 62 generated by the user, who for example exerts a pressure on one of the fingers or on the palm of the gloved hand, or makes a characteristic overall gesture with the hand like a clenched fist.

Where appropriate, the neural network 64 is used to recognize a more complex gesture, of the fingers and/or the arm of the user, by virtue of knowledge of the position of the glove relative to a reference frame that may or may not be tied to the user.

To determine the position of the glove relative to a reference frame external to the glove, the glove may comprise a first transceiver module 7, which may communicate via a two-way wireless link with an external second module 8, in order to determine the position of the interface 1 relative to the reference frame of the external module 8.

As illustrated in FIG. 12, the first module 7 may be located in the wrist region and the external second module 8 may be worn by the user, for example on a belt. Thus in the example in question, it is possible to detect the height at which the movement of the fingers is made with respect a reference frame relative to the upper half of the body.

In other examples of embodiment, the external module 8 may be located in other places on the user, for example in a pocket or on a headset.

It is also possible to use a module 8 that is fixed in the exterior environment and not worn by the user, for example a module that is fixed to a wall or to an item of equipment, a stationary vehicle for example, this allowing the spatial position of the gloved hand to be determined. There may also be a plurality of external modules 8 that communicate with the module 7 of the glove, for example in order to increase the accuracy of location of the glove in this external reference frame.

By determining the position of the gloved hand relative to the external reference frame tied to the one or more external modules 8, it is possible to discriminate between finger gestures that are identical but made in distinct spatial positions, for example above the head, at the shoulder level, the thorax level, etc. New gestures involving finger and arm movements may be detected. The number of identifiable gestures is thereby increased, thus enriching the possibilities in respect of application of the invention.

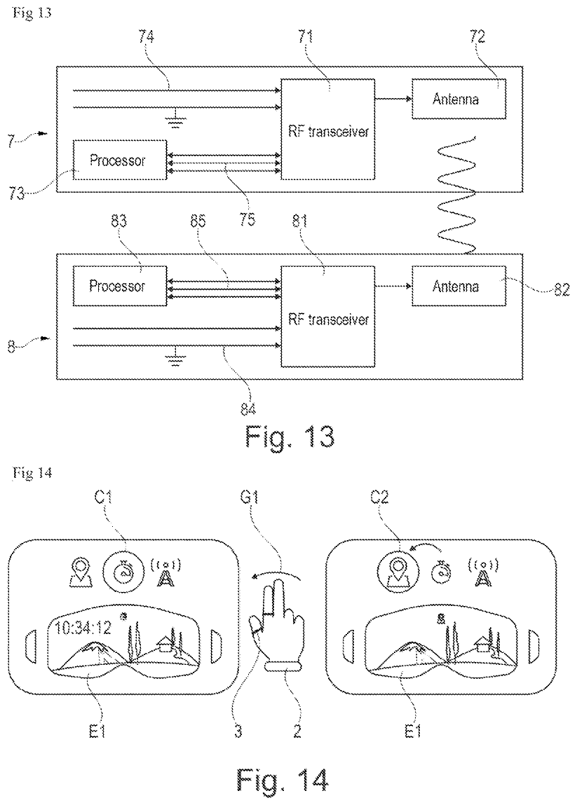

The module 7 and the module 8 preferably communicate via radio-telemetry, for example with UWB technology. The position of the module 7 may be estimated by virtue of the shift in the radio time of arrival of the signal, i.e. by measuring the propagation time of the signals. As illustrated in FIG. 13, the module 7 comprises an RF transceiver 71, which transmits and receives signals by virtue of an antenna 72. The data 75 to be transmitted or received are processed by a processor 73. The module 7 of the glove is for example powered via a wired connection 74 connected to the power supply 5 common with the processing circuit 2. The external module 8 comprises, similarly to the module 7, an RF transceiver 81, an antenna 82 and a processor 83 that processes the transmitted or received data 85. The external module 8 is for example connected to an external power supply by a wired connection 84.

The detection of a predefined gesture may be used to control ancillary equipment, for example augmented reality glasses E1, as illustrated in FIG. 14. In the example in question, the predefined gesture G1 consists of joining the index and middle fingers along their length and making a lateral movement of the hand to the left with the fingers thus joined.

The equipment E1 for example comprises a menu, which is displayed, and the interface 1 allows a selection within this menu. In this example, the glasses E1 display a stopwatch C1 at a given time, and the user (a runner or hiker for example) selects, by performing the gesture G1, the function C2 of display of geolocation data instead of the display of the stopwatch.

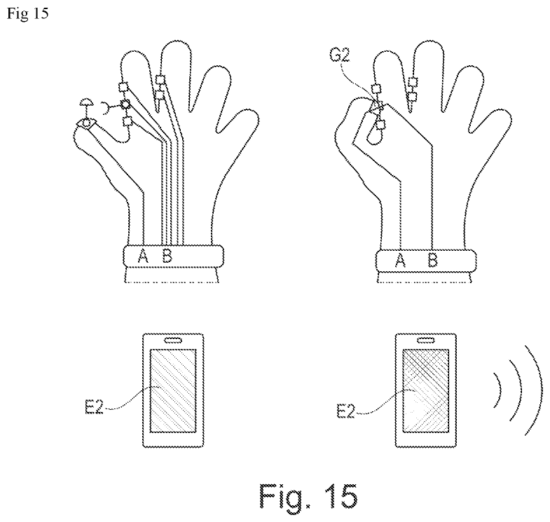

The equipment connected to the interface may also receive therefrom data resulting from detection of a mutual press between two predefined contact points 4, as shown in FIG. 15.

The equipment E2 is a walkie-talkie in this example and the data output from interface 1 control a state of transmission or of listening of the walkie-talkie. When the user makes a gesture G2 consisting in joining his or her thumb and index finger, the processing circuit 2 detects contact at points A and B and for example commands the telephone E2 to answer a call, without the user having to interact via direct contact with the walkie-talkie.

The contact points integrated into the glove may be located on the fingers as described above, or any other part of the hand, the palm or wrist for example.

The fingers of the glove may have a plurality of contact points 4, for example one on each phalange of one or more fingers, or even one or more on the palm of the hand or its edge.

Detection of a mutual press between two predefined contact points may thus occur as a result of a press between two fingers as illustrated in FIG. 15, or as a result of any other possible press depending on the arrangement of the contact points on the glove—for example, a press between four fingers with at least one contact on each of the fingers or between a finger and the palm with at least one contact on the finger and at least one contact on the palm.

Detection of a mutual press between two predefined contact points may occur in a context where there are, at a given time, only two contact points of the glove in mutual contact, or alternatively in a context where more mutual presses exist concomitantly.

The processing circuit may be arranged to detect two or more mutual presses, simultaneously or sequentially, and to deduce therefrom one or more commands depending on the corresponding combinations of presses recognized. For example, the control circuit may be arranged to detect that the user has joined his or her thumb and index finger and simultaneously brought another of his or her fingers, his or her little finger for example, into contact with the palm of his or her hand (or any other region of the glove where a point of contact is located).

Of course, the invention is not limited to the examples that have just been described.

For example, the emitters 3 or their coils are placed on different phalanges of the same finger.

The interface may be connected to a plurality of items of third-party equipment and help the user to control these devices simultaneously.

The invention may further be used to allow the user to improve his or her means of communicating with persons or third-party peripherals, for example in the context of users who require assistance due to a physical handicap or following an accident.

The model used to identify the predefined gesture made by the user may be based on a neural network or another suitable computational tool.

1. A human-machine interface, comprising
a glove comprising
at least one emitter integrated into the glove, comprising at least one coil for emitting a magnetic field, said coil being placed on a finger of the glove such that the orientation of the emitted field relative to a reference direction in a reference frame tied to the glove varies with the orientation of the finger,
at least one processing circuit integrated into the glove, comprising at least one receiver of the signal emitted by the emitter, said circuit being configured to process the received signal in order to determine at least the orientation of the coil of the emitter in said reference frame,
the processing circuit being arranged to detect a mutual press between two predefined contact points of the glove, these contact points being placed on the glove so as to allow the user to selectively bring these points into contact or not, by moving at least one finger of the hand.

2. The interface as claimed in claim 1, the glove comprising at least one electrical source common to the emitter and to the processing circuit, for supplying electricity to them, preferably an electrical source placed on top of the hand or in the wrist region.

3. The interface as claimed in claim 1, at least one contact point being located on the thumb and at least one other being located on the index and/or middle finger.

4. The interface as claimed in claim 1, the contact points each comprising an electrode connected by a wired connection to the processing circuit.

5. The interface as claimed in claim 1, the processing circuit being arranged to detect a press on a contact point via resistive, capacitive, optical, electromechanical, thermal, inductive, piezo-resistive or piezoelectric detection.

6. The interface as claimed in claim 1, the glove comprising at least a first module able to communicate via a wireless link, and preferably via two-way radio-telemetry, with at least a second module external to the glove in order to determine the position of the glove relative to a reference frame tied to the external module.

7. The interface as claimed in claim 1, comprising at least two emitters the respective coils of which are placed on two different fingers or on two different phalanges of the same finger.

8. The interface as claimed in claim 7, the emitters emitting at different frequencies, the processing circuit being arranged to discriminate between the signals of each emitter.

9. The interface as claimed in claim 1, the processing circuit being arranged to determine the amplitude and phase of the signal received by the receiver and originating from the emitter.

10. The interface as claimed in claim 1, comprising at least one emitter or emitter coil on each of the thumb, index finger and middle finger.

11. The interface as claimed in claim 1, the or each emitter or emitter coil being electrically powered via a wired connection.

12. The interface as claimed in claim 1, the processing circuit being located in the wrist region.

13. The interface as claimed in claim 1, the processing circuit comprising a transmitter for transmitting data to third-party equipment via a wireless link, these data resulting from the detected orientation and/or gesture.

14. The interface as claimed in claim 1, the processing circuit being configurable so as to allow a user to define a command to be generated as output depending on at least one detected orientation and/or gesture.

15. The interface as claimed in claim 1, the processing circuit comprising at least one neural network trained beforehand to recognize a predefined gesture made by the user with his or her hand, and especially a finger or hand gesture made at a predefined height relative to the body.

16. An assembly comprising
an interface such as defined in claim 1,
an item of equipment able to be connected to the interface so as to receive therefrom data generated as output depending on at least one detected orientation and/or gesture.

17. The assembly as claimed in claim 16, the item of equipment comprising at least one display device, and the output data controlling a pointer and/or a selection tool in an image displayed by the display device.

18. The assembly as claimed in claim 16, the item of equipment comprising a transceiver and the output data controlling a state of transmission or of the receiver listening.

19. A method for generating at least one item of information for delivery to an item of equipment, using an interface such as defined in claim 1, comprising the steps of:
detection of the orientation of at least the finger equipped with the emitter or with the coil of the emitter, and especially a predefined gesture of the hand,
based on this detection, generating a predefined item of information for delivery to the item of equipment.

20. The method as claimed in claim 19, wherein the position of the hand relative to a reference frame external to the glove, especially a reference frame tied to the user, is also detected, and knowledge of the orientation and/or position of the fingers in the reference frame tied to the glove and of the glove in the reference frame tied to the user is used to discriminate between gestures involving a movement of the fingers and of the hand.
